(19) United States
(12) Patent Application Publication
(10) Pub. No.: US 2026/0163090 A1
(43) Pub. Date: Jun. 11, 2026

(54) TEST BATTERY CELL, TEST DEVICE INCLUDING THE SAME, AND BATTERY APPARATUS INCLUDING THE SAME

(71) Applicant: SK On Co., Ltd., Seoul (KR)

(72) Inventors: June Sun HWANG, Daejeon (KR); Moon Gil BANG, Daejeon (KR); Jung Hyun SEO, Daejeon (KR); Tae Gyun YU, Daejeon (KR); Kyeong Min LEE, Daejeon (KR)

(21) Appl. No.: 19/414,285

(22) Filed: Dec. 10, 2025

(30) Foreign Application Priority Data
Dec. 10, 2024 (KR) 10-2024-0182632

(51) Int. Cl. H01M 10/48; H01M 10/04; H01M 10/42; H01M 50/505; H01M 50/557; H01M 50/562; H01M 50/569

(52) U.S. Cl. CPC H01M 10/482; H01M 10/0459; H01M 10/4257; H01M 10/4285; H01M 10/486; H01M 50/505; H01M 50/557; H01M 50/562; H01M 50/569

(57) ABSTRACT

The present disclosure relates to a test battery cell, a test device including the same, and a battery apparatus including the same. The test battery cell according to an embodiment of the present disclosure may include: a case including an accommodating space; at least one cathode plate accommodated in the accommodating space and including a cathode tab; at least one anode plate accommodated in the accommodating space and including an anode tab; at least one separator separating the at least one cathode plate from the at least one anode plate; and a conduction member in contact with the anode plate and including a material overlapping a material of the cathode tab.

### CROSS-REFERENCE TO RELATED APPLICATION(S)

This patent document claims the priority and benefits of Korean Patent Application No. 10-2024-0182632 filed on Dec. 10, 2024, the disclosure of which is incorporated herein by reference in its entirety.

### TECHNICAL FIELD

The present disclosure relates to a test battery cell, a test device including the same, and a battery apparatus including the same.

### BACKGROUND

A battery is widely used not only in small electronic devices such as mobile phones and laptop computers, but also in medium and large-sized mechanical devices such as electric vehicles (EVs) and energy storage devices, and may be charged and reused.

An electrode assembly including a cathode plate and an anode plate may be accommodated in a case selected for use, such as a pouch type, a prismatic type, a cylindrical type, and the like, and an electrolyte may be injected thereinto to manufacture a battery cell.

A battery module, a battery pack, an energy storage system (ESS), and the like may be manufactured by connecting a plurality of battery cells with a busbar or the like.

In the battery module, the battery pack, the energy storage device, and the like, a thermal event related to an internal short circuit of the battery cell, a venting gas, a flame, and the like may occur. Such a thermal event may generate thermal propagation, thermal runaway, or the like, in a device such as a battery module, a battery pack, and or an energy storage device. Accordingly, there is a need to find a way to prevent thermal events such as a thermoelectric wave, thermal runaway, or the like, of the battery cell.

### SUMMARY

According to one aspect of the present disclosure, provided are a test battery cell for testing and/or experimenting with regard to thermal events affecting a battery cell and/or a battery apparatus, a test system thereof, and a battery apparatus including the same.

In addition, the present disclosure may be widely applied in green technology fields such as solar power generation and wind power generation.

In addition, the present disclosure may be applied to eco-friendly devices such as electric vehicles and hybrid vehicles to prevent climate change by suppressing air pollution and greenhouse gas emissions.

A test battery cell according to an embodiment of the present disclosure may include: a case including an accommodating space; at least one cathode plate accommodated in the accommodating space and including a cathode tab; at least one anode plate accommodated in the accommodating space and including an anode tab; at least one separator separating the at least one cathode plate from the at least one anode plate; and a conduction member in contact with the anode plate and including a material overlapping a material of the cathode tab.

In an embodiment, the cathode tab may be formed of a material including aluminum.

In an embodiment, in the cathode tab, at least a partial region thereof may be exposed to the outside of the case.

In an embodiment, the at least one cathode plate may include a plurality of cathode plates, and the at least one anode plate may include a plurality of anode plates, and in the separator, a single separator may be folded and may be interposed between the at least one cathode plate and the at least one anode plate.

Meanwhile, according to another aspect, the present disclosure provides a test system for a test battery cell, including: a test battery cell including a case including an accommodating space, at least one cathode plate accommodated in the accommodating space and including a cathode tab, at least one anode plate accommodated in the accommodating space and including an anode tab, at least one separator separating the at least one cathode plate from the at least one anode plate, and a conduction member in contact with the anode plate and including a material overlapping a material of the cathode tab; a first conductive line connected to the conductive member; a second conductive line connected to the cathode tab; a relay connected to the first and second conductive lines; and a power supply connected to the relay and applying a voltage.

In an embodiment, the test system for a test battery cell may further include a first bolt penetrating through the conductive member and formed of an electrically conductive material.

In an embodiment, the test system for a test battery cell may further include a second bolt penetrating through the cathode tab and formed of an electrically conductive material; and a second nut connected to the second bolt.

In an embodiment, the first conductive line and the second conductive line may be exposed to the outside of the case, and a connection region between the first conductive line and the relay and a connection region between the second conductive line and the relay may be disposed outside the case.

Meanwhile, according to another aspect, the present disclosure provides a battery apparatus including: a housing including an internal space; a plurality of battery cells accommodated in the housing, and respectively including an electrode assembly; and a test system for a test battery cell, wherein at least a partial region thereof is accommodated in the housing, the test system for a test battery cell including: the test battery cell including a case including an accommodating space, at least one cathode plate accommodated in the accommodating space and including a cathode tab, at least one anode plate accommodated in the accommodating space and including an anode tab, at least one separator separating the at least one cathode plate from the at least one anode plate, and a conduction member in contact with the anode plate and including a material overlapping a material of the cathode tab; a first conductive line connected to the conductive member; a second conductive line connected to the cathode tab; and a relay connected to the first and second conductive lines.

In an embodiment, the battery apparatus may further include a busbar assembly connecting the plurality of battery cells and the test battery cell.

In an embodiment, the relay may be disposed outside the housing.

In an embodiment, the battery apparatus may further include at least one sensor member disposed within the internal space.

In an embodiment, the at least one sensor member may include: a temperature sensor measuring temperature; and a voltage sensor measuring voltage.

In an embodiment, the battery apparatus may further include a power supply connected to the relay and applying voltage.

In an embodiment, the power supply may be disposed outside the housing.

According to an aspect of the present disclosure, a test battery cell for testing and/or experimenting on a thermal event occurring in a battery cell and/or a battery apparatus, a test system thereof, and a battery apparatus including the same may be provided.

In addition, the present disclosure may be widely applied in green technology fields such as solar power generation and wind power generation.

In addition, the disclosure may be applied to eco-friendly devices such as electric vehicles and hybrid vehicles to prevent climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 schematically illustrates a cathode plate, an anode plate, and a separator of a test battery cell according to an embodiment of the present disclosure.

FIG. 2 schematically illustrates a perspective view of a cathode plate, an anode plate, and a separator of a test battery cell according to an embodiment of the present disclosure.

FIG. 3 schematically illustrates a test battery cell according to an embodiment of the present disclosure.

FIG. 4 schematically illustrates a test system for a battery cell according to an embodiment of the present disclosure.

FIG. 5 schematically illustrates a plan view of a test system for a battery cell in a state in which a relay is turned off.

FIG. 6 schematically illustrates a plan view of a test system for a battery cell in a state in which a relay is turned on.

FIG. 7 schematically illustrates a cross-section of a conductive member according to an embodiment of the present disclosure.

FIG. 8 schematically illustrates an exploded perspective view of a battery apparatus according to an embodiment of the present disclosure.

FIG. 9 schematically illustrates an exploded perspective view of a battery apparatus according to another embodiment of the present disclosure.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of respective components do not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings.

Hereinafter, an X-axis illustrated in the drawing indicates a width direction of a test battery cell 100 or a width direction of a cathode plate 120, a Y-axis indicates a thickness direction of the test battery cell 100 or a thickness direction of the cathode plate 120, and a Z-axis indicates a height direction of the test battery cell 100 or a height direction of the cathode plate 120. However, this is a direction arbitrarily set for convenience of understanding, and the direction may be changed.

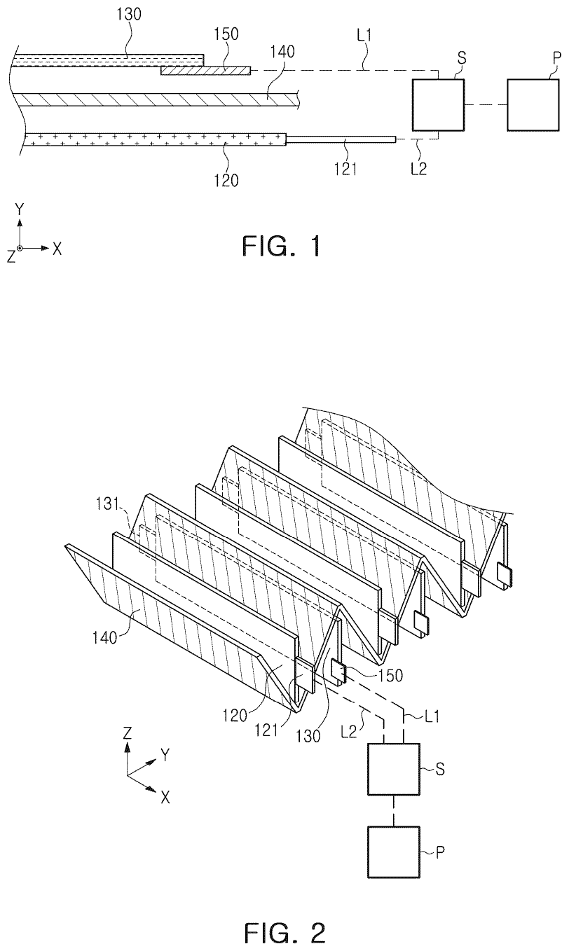

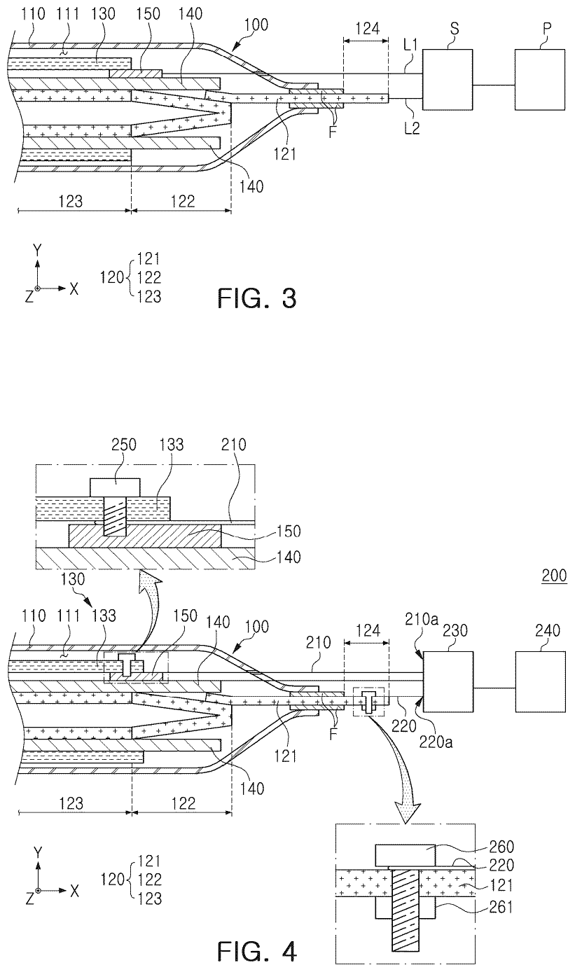

FIG. 1 schematically illustrates a cathode plate 120, an anode plate 130, and a separator 140 of a test battery cell 100 according to an embodiment of the present disclosure, FIG. 2 schematically illustrates a perspective view of a cathode plate 120, an anode plate 130, and a separator 140 of a test battery cell 100 according to an embodiment of the present disclosure, and FIG. 3 schematically illustrates a test battery cell 100 according to an embodiment of the present disclosure.

As illustrated in FIGS. 1 to 3, the test battery cell 100 according to an embodiment of the present disclosure may include: a case 110 including an accommodating space 111; at least one cathode plate 120 accommodated in the accommodating space 111 and including a cathode tab 121; at least one anode plate 130 accommodated in the accommodating space 111 and including an anode tab 131; at least one separator 140 separating the at least one cathode plate 120 from the at least one anode plate 130; and a conductive member 150 in contact with the anode plate 130 and including a material overlapping a material of the cathode tab 121.

The test battery cell 100 may include at least one cathode plate 120, at least one anode plate 130, and at least one separator 140 separating the at least one cathode plate 120 from the at least one anode plate 130.

The at least one cathode plate 120, the at least one anode plate 130 and the at least one separator 140 may be stacked or arranged. The at least one separator 140 may be interposed between the at least one cathode plate 120 and the at least one anode plate 130.

For example, the separator 140 may be provided as a single separator 140, and the cathode plate 120 or the anode plate 130 may be disposed between the separators 140 by folding the single separator 140. Accordingly, the cathode plate 120 and the anode plate 130 may be separated from each other by the separator 140.

An electrode assembly may be formed with the at least one cathode plate 120, the at least one anode plate 130, and the at least one separator 140. The electrode assembly may also include a plurality of cathode plates 120, a plurality of anode plates 130, and a plurality of separators 140.

The cathode plate 120 may be manufactured by applying a cathode active material to a cathode current collector, and the anode plate 130 may be manufactured by applying an anode active material to an anode current collector. A region of the cathode plate 120 to which the cathode active material is applied may be a cathode active material region 123, and a region of the cathode plate 120 to which the cathode active material is not applied may be a cathode non-coated region 122.

In an embodiment, the cathode tab 121 may be formed of a material including aluminum. For example, the cathode current collector may be formed of a material including aluminum, stainless steel, nickel, titanium, copper, or alloys thereof. The cathode active material may be in the form of a slurry in which not only the cathode active material but also a binder, a conductive agent, a dispersant, and the like, are mixed and stirred.

The anode current collector may be formed of a material including copper, gold, stainless steel, nickel, aluminum, titanium, or alloys thereof. The anode active material may be in the form of a slurry in which not only the anode active material but also a binder, a conductive agent, a dispersant, and the like, are mixed and stirred.

A region of the anode plate 130 to which the anode active material is applied may be an anode active material region 132, and a region of the anode plate 130 to which the anode active material is not applied may be an anode non-coated region. The anode non-coated region may include an anode tab 131.

For example, the cathode current collector and the anode current collector may be formed of a material including a metal such as Co, Mn, or Li. Additionally, for example, the anode active material or the cathode active material may not be applied to the anode tab 131 and the cathode tab 121.

As illustrated in FIG. 3, in an embodiment, at least a partial region of the cathode tab 121 may be exposed to the outside of the case 110. A region of the cathode tab 121 exposed to the outside of the case 110 may be an exposed region 124.

The case 110 may include an accommodating space 111, and the accommodating space 111 may accommodate an electrode assembly including the cathode plate 120, the anode plate 130, and the separator 140. This may be in the form of a stacked film of polyethylene terephthalate (PET), nylon, and aluminum.

The case 110 may be sealed in a state in which the electrode assembly and an electrolyte are accommodated in the accommodating space 111. In an embodiment, the test battery cell 100 may be a pouch-type battery cell.

Furthermore, in an embodiment, at least one cathode plate 120 may include a plurality of cathode plates 120, and at least one anode plate 130 may include a plurality of anode plates 130. Furthermore, in the separator 140, a single separator 140 may be folded, and the single separator 140 may be interposed between the at least one cathode plate 120 and the at least one anode plate 130.

In an embodiment, the cathode tab 121 of the cathode plate 120 and the anode tab 131 of the anode plate 130 may be disposed non-face-to-face with each other. For example, the cathode tab 121 and the anode tab 131 may be disposed to be offset from each other in a thickness direction (Y direction) of the cathode plate 120 and may not face each other. Accordingly, the cathode tab 121 and the anode tab 131 may not overlap each other in a thickness direction of the cathode tab 121 or a thickness direction (Y direction) of the anode tab 131.

However, the plurality of cathode tabs 121 may overlap each other in the thickness direction (Y direction) of the cathode plate 120, and the plurality of anode tabs 131 may also overlap each other in the thickness direction (Y direction) of the cathode plate 120.

As illustrated in FIG. 3, in an embodiment of the present disclosure, the plurality of cathode plates 120 may be disposed between the separators 140. Cathode non-coated regions 122 of the plurality of cathode plates 120 may be in contact with each other. In some cases, the plurality of cathode non-coated regions 122 may be connected to each other by ultrasonic welding, or the like.

Additionally, the separator 140 may be disposed between the cathode plate 120 and the case 110, and between the anode plate 130 and the case 110. Accordingly, the cathode plate 120 and the case 110, and the anode plate 130 and the case 110, may be electrically insulated from each other.

The plurality of cathode non-conducting regions 122 may be electrically connected to the cathode tab 121. The plurality of cathode non-conducting regions 122 and the cathode tab 121 may be connected by laser welding or the like, but a connection method is not necessarily limited by the present disclosure.

A lead film may be interposed between the cathode tab 121 and the case 110. The lead film may be formed of a material having electrical insulation and may electrically insulate the cathode tab 121 and the case 110. A plurality of lead films may be provided, and the plurality of lead films may be disposed between one surface of the cathode tab 121 and the case 110, and between the other surface of the cathode tab 121 and the case 110.

A second wire L2 may be connected to the exposed area 124 of the cathode tab 121. The second wire L2 may be formed of an electrically conductive material and may be connected to a switch member S.

A first wire L1 may also be connected to the switch member S. The first wire L1 may be formed of an electrically conductive material and may electrically connect the switch member S and the conductive member 150. In an embodiment, the first wire L1 may penetrate through the case 110 and may be inserted into the accommodating space 111.

In this case, a contact region between the first wire L1 and the case 110 may be electrically insulated by an insulating material. The insulating material may also serve to seal the case 110. The insulating material may be disposed between an outer surface of the first wire L1 and the case 110, and may seal a region of the case 110 penetrated by the first wire L1. Accordingly, leakage of electrolyte, or the like, may be prevented. The switch member S may be provided separately and may be connected to a power supply P, or may be a switch member S provided in the power supply P. The switch member S may electrically connect the power supply P, the cathode tab 121, and the anode plate 130. Accordingly, as voltage is applied from the power supply P and the switch member S is turned on, a short circuit may be generated between the cathode tab 121 and the anode plate 130.

In an embodiment, the conductive member 150 may be formed of an electrically conductive material, and may be the same material as the cathode tab 121. For example, the cathode tab 121 and the conductive member 150 may be formed of a material including aluminum. Accordingly, an actual battery cell usage environment and a thermal runaway environment of the battery cell may be simulated. Furthermore, the thermal runaway test environment may be simulated similarly to an actual thermal runaway situation of the battery cell. Accordingly, the reliability of the thermal runaway test results may be improved.

For example, in actual battery cell usage environments, a short circuit and thermal runaway may occur when the cathode tab 121 is folded or bent. Accordingly, according to the present disclosure, a short circuit environment and a thermal runaway environment caused by folding of the cathode tab 121 may be implemented.

The present disclosure may induce a short circuit between the cathode tab 121 and the anode plate 130 and may simulate a short circuit between the cathode tab 121 and the anode plate 130.

In an embodiment, the conductive member 150 may be disposed between the anode plate 130 and the separator 140.

In an embodiment, the conductive member 150 may be secured to the anode plate 130 using tape, bolts, or the like. The conductive member 150 and the case 110 may be electrically insulated from each other. The conductive member 150 may be separated from the case 110, and a separate insulating material may be provided between the conductive member 150 and the case 110. In this case, the insulating material may be a separator 140.

When the switch member S is turned on and voltage is applied by the power supply P, a short circuit may occur, and the conductive member 150 may generate heat. In some cases, the heat may deform or damage the separator 140, and in such cases, a chain reaction of short circuits may occur. Accordingly, various thermal runaway environments may be implemented.

FIG. 4 schematically illustrates a battery cell test system 200 according to an embodiment of the present disclosure.

As illustrated in FIG. 4, the present disclosure provides the battery cell test system 200 including the test battery cell 100.

As illustrated in FIGS. 1 to 4, the present disclosure provides a test device for a test battery cell 100, including: a case 110 including an accommodating space 111; at least one cathode plate 120 accommodated in the accommodating space 111 and including a cathode tab 121; at least one anode plate 130 accommodated in the accommodating space 111 and including an anode tab 131; at least one separator 140 separating the at least one cathode plate 120 from the at least one anode plate 130; and a conductive member 150 in contact with the anode plate 130 and including a material overlapping the material of the cathode tab 121.

A battery cell test system 200 according to an embodiment of the present disclosure may include: a test battery cell 100 including a case 110 including an accommodating space 111, at least one cathode plate 120 accommodated in the accommodating space 111 and including a cathode tab 121, at least one anode plate 130 accommodated in the accommodating space 111 and including an anode tab 131, at least one separator 140 separating the at least one cathode plate 120 from the at least one anode plate 130, and a conductive member 150 in contact with the anode plate 130 and including a material overlapping a material of the cathode tab 121; a first conductive line 210 connected to the conductive member 150; a second conductive line 220 connected to the cathode tab 121; a relay 230 connected to the first conductive line 210 and the second conductive line 220; and a power supply 240 connected to the relay 230 and applying voltage.

The first conductive line 210 and the second conductive line 220 may be formed of an electrically conductive material and may be wires. The first conductive line 210 and the second conductive line 220 may be connected to the relay 230. The relay 230 may function as a switch and may be connected to a power supply 240.

The power supply 240 may apply voltage to the relay 230. The relay 230 may be turned on or off by the power supply 240.

For example, the power supply 240 may supply power to the relay 230. An AC-DC power supply, a DC-DC power supply, or the like, may be applied thereto, but the type of power supply 240 is not limited by the present disclosure.

One side of the first conductive line 210 may be secured to the conductive member 150, and the other side of the first conductive line 210 may be connected to the relay 230. One side of the second conductive line 220 may be secured to the cathode tab 121, and the other side of the second conductive line 220 may be connected to the relay 230.

A battery cell test system 200 according to an embodiment of the present disclosure may further include a first bolt 250 penetrating through the conductive member 150 and formed of an electrically conductive material. The first bolt 250 may be disposed in the accommodating space 111, and the first conductive line 210 may be wound around the first bolt 250.

The first bolt 250 may penetrate through the conductive member 150 and may be secured to the anode plate 130. A head portion of the first bolt 250 may apply pressure to the first conductive line 210, and may prevent the first conductive line 210 from releasing contact with the conductive member 150. Accordingly, the first conductive line 210 may be maintained in contact with the conductive member 150 by the first bolt 250.

Accordingly, the first conductive line 210 may be easily coupled to the conductive member 150. In this case, an outer surface of the first bolt 250 may be provided with a material having electrical insulation.

Additionally, in an embodiment, the battery cell test system 200 may further include a second bolt 260 penetrating through the cathode tab 12 and formed of an electrically conductive material and a second nut 261 coupled to the second bolt 260.

For example, the second bolt 260 may penetrate through the cathode tab 121 and the second conductive line 220 in a state in which the second conductive line 220 is in contact with one surface of the cathode tab 121. Alternatively, the second conductive line 220 may be wound around an outer surface of the second bolt 260, and the second conductive line 220 may be prevented from separating from the cathode tab 121 by the second bolt 260.

In an embodiment, the outer surface of the second bolt 260 may be provided with the material having electrical insulation. In this case, the second conductive line 220 may need to remain in contact with one surface of the cathode tab 121. However, when the second bolt 260 is formed of the electrically conductive material, the second bolt 260 may serve as a medium for electrical connection between the second conductive line 220 and the cathode tab 121. This principle may also be applied to the first bolt 250.

In an embodiment, a contact region of the second bolt 260, the cathode tab 121 and the second conductive line 220 may be disposed outside the case 110.

However, a clip, stapler, or the like, may be applied instead of the first bolt 250 and the second bolt 260.

Furthermore, in an embodiment, at least a partial region of the first conductive line 210 and the second conductive line 220 may be exposed to the outside of the case 110. Additionally, a connection region between the first conductive line 210 and the relay 230 and a connection region between the second conductive line 220 and the relay 230 may be disposed outside the case 110.

The connection region between the first conductive line 210 and the relay 230 may be a first connection region, and the connection region between the second conductive line 220 and the relay 230 may be a second connection region. The first connection region and the second connection region may be disposed outside the case 110. According to the configuration described above, a short circuit simulation between the cathode tab 121 and the anode plate 130 may be easily implemented.

In some cases, the first conductive line 210 and the anode plate 130 may be coupled using a tape, or the like, and the second conductive line 220 and the cathode tab 121 may also be coupled using the tape, or the like.

The relay 230 may be electrically turned on or off depending on whether voltage is applied from the power supply 240. When the relay 230 is turned on, a short circuit may occur between the cathode tab 121 and the anode plate 130. Accordingly, a phenomenon of a short circuit occurring due to warpage or bending of the cathode plate 120 may be simulated without physically warping or bending the cathode plate 120.

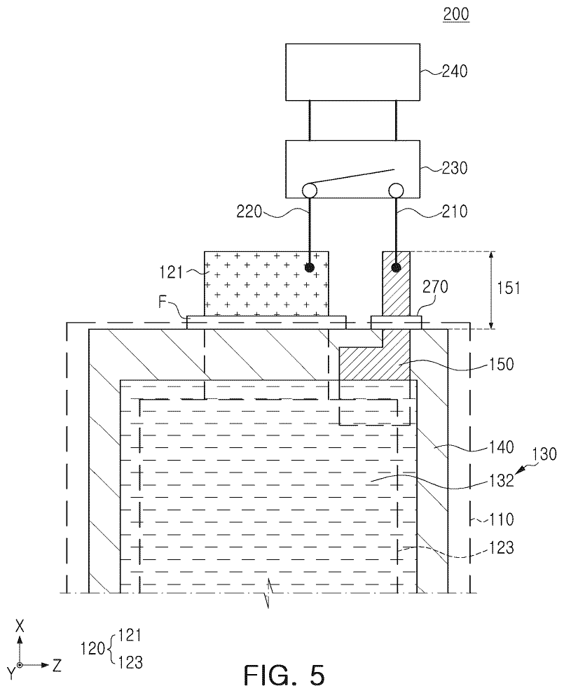

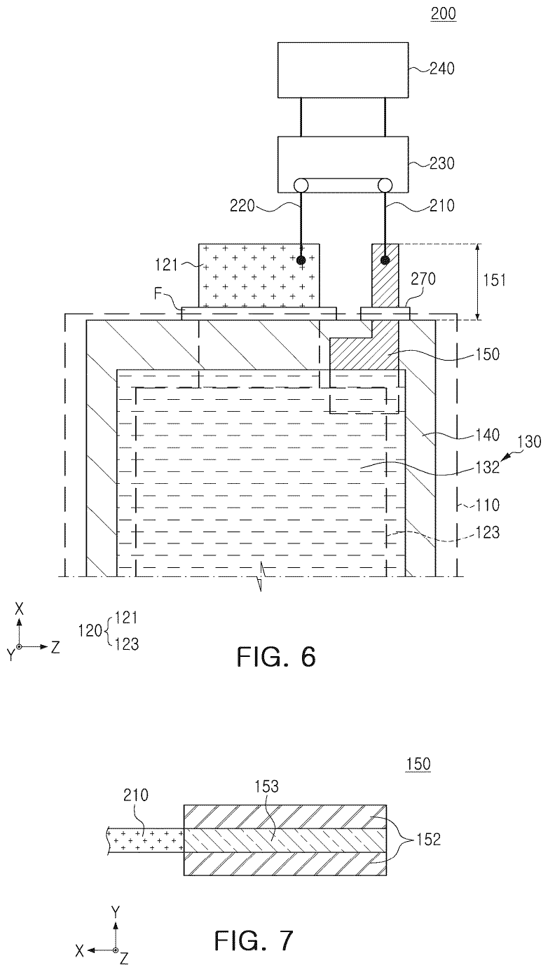

FIG. 5 is a schematic plan view of a battery cell test system 200 in a state in which the relay 230 is turned off, and FIG. 6 is a schematic plan view of a battery cell test system 200 in a state in which the relay 230 is turned on.

The relay 230 may be connected to the conductive member 150 and the cathode tab 121 via the first conductive line 210 and the second conductive line 220, respectively. The relay 230 may be turned on or off depending on whether voltage is supplied from the power supply 240.

As illustrated in FIG. 5, the relay 230 may be turned off when voltage is not supplied from the power supply 240, and an electrical connection between the cathode tab 121 and the conductive member 150 may be released.

Conversely, as illustrated in FIG. 6, the relay 230 may be turned on when voltage is supplied from the power supply 240, and the cathode tab 121 and the conductive member 150 may be electrically connected.

When the cathode tab 121 and the conductive member 150 are electrically connected, a short circuit may occur, resulting in heat generation. Accordingly, a thermal runaway situation in a battery cell may be simulated.

The resistance may be adjusted by changing the specifications, and the like, of the relay 230, the first conductive line 210, and the second conductive line 220.

Additionally, the amount of heat generated may be controlled by adjusting an area of the conductive member 150.

Additionally, in an embodiment of the present disclosure, the conductive member 150 may include an extension region 151. The extension region 151 may extend in a direction away from the anode active material region 132 to face the cathode tab 121.

In an embodiment, the extension region 151 may be exposed to the outside of the case 110. In this case, an insulating member 270, which is formed of a material having electrical insulation, may be provided between the case 110 and the extension region 151.

In this case, the first conductive line 210 may be connected to the extension region 151, and a contact area between the extension region 151 and the first conductive line 210 may be disposed outside the case 110. Accordingly, there is no need to form a through-hole, or the like, for inserting the first conductive line 210 into the case 110.

FIG. 7 schematically illustrates a cross-section of a conductive member 150 according to an embodiment of the present disclosure.

As illustrated in FIG. 7, the conductive member 150 may include a plurality of aluminum plates 152 and an adhesive member 153. The plurality of aluminum plates 152 may be bonded by the adhesive member 153. The adhesive member 153 may be an electrically conductive adhesive, and may be, for example, silver.

The adhesive member 153 may not only connect the plurality of aluminum plates 152 but may also be connected to the first conductive line 210. Accordingly, the first conductive line 210, the adhesive member 153, and the plurality of aluminum plates 152 may be electrically connected to each other.

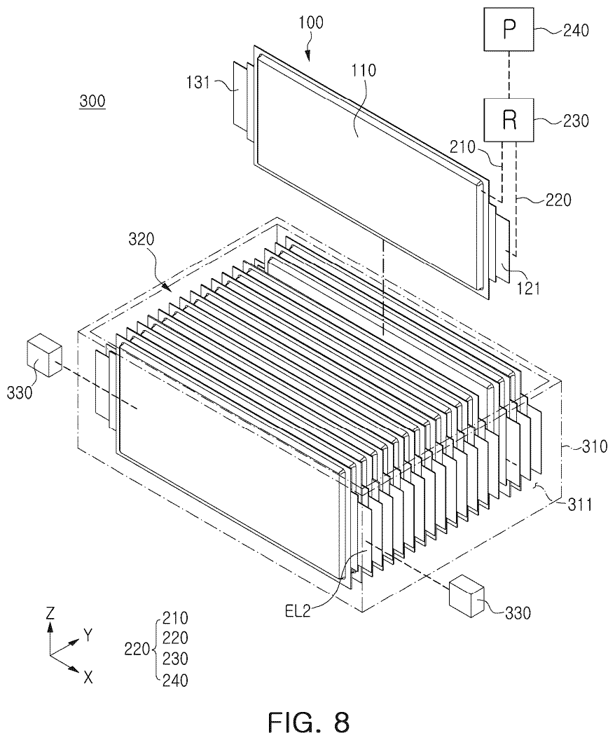

Meanwhile, in another aspect, the present disclosure provides a battery apparatus 300. FIG. 8 is a schematic exploded perspective view of a battery apparatus 300 according to an embodiment of the present disclosure.

The battery apparatus 300 according to the present disclosure may be utilized to simulate a thermal runaway condition of the battery apparatus 300 and may include a test battery cell 100 and a test system 200 for the test battery cell.

As illustrated in FIG. 8, the present disclosure may include a housing 310 including an internal space 311, a plurality of battery cells 320 accommodated in the housing 310, and respectively including battery cell including an electrode assembly, and a test system 200 for the test battery cell, at least a portion of which is accommodated in the housing 310. In this case, the test system 200 for the test battery cell may include a test battery cell 100 including a case 110 including an accommodating space 111, at least one cathode plate 120 accommodated in the accommodating space 111 and including a cathode tab 121, at least one anode plate 130 accommodated in the accommodating space 111 and including an anode tab 131, at least one separator 140 separating the at least one cathode plate 120 from the at least one anode plate 130, and a conductive member 150 in contact with the anode plate 130 and including a material overlapping a material of the cathode tab 121. Additionally, the test system 200 for the test battery cell may include a first conductive line 210 connected to the conductive member 150, a second conductive line 220 connected to the cathode tab 121, a relay 230 connected to the first conductive line 210 and the second conductive line 220, and a power supply 240 connected to the relay 230 and applying voltage.

The plurality of battery cells 320 may be pouch-type battery cells 320. The battery cells 320 may include an electrode assembly including a cathode plate 120, an anode plate 130, and a separator 140, and an electrolyte, inside an exterior material. The exterior material may be sealed, but a partial region of a first electrode lead EL1 connected to the cathode plate 120 and a partial region of a second electrode lead EL2 connected to the anode plate 130 may be exposed to the outside of the exterior material.

In an embodiment, the battery apparatus 300 may further include a busbar assembly 330 connecting the plurality of battery cells 320 and the test battery cell 100.

The busbar assembly 330 may be electrically connected to the first electrode lead EL1 and the second electrode lead EL2.

The busbar assembly 330 may include a busbar member formed of an electrically conductive material and an insulating plate supporting the busbar member, but the present disclosure is not necessarily limited by the present disclosure.

A plurality of busbar assemblies 330 may be provided, and in this case, the busbar members may be connected to a plurality of first electrode leads EL1 and a plurality of second electrode leads EL2. The busbar assembly 330 may be accommodated in an internal space 311 of the housing 310 along with a plurality of battery cells 320.

The test battery cell 100 may be interposed between the plurality of battery cells 320. The test battery cell 100 may be accommodated in the internal space 311 of the housing 310. In some cases, a pad may be further provided between the plurality of battery cells 320 to provide surface pressure and insulation.

The test battery cell 100 and the test system 200 for the test battery cell may be according to at least one of the above-described embodiments.

In an embodiment, the relay 230 and the power supply 240 may be disposed outside the housing 310. Accordingly, even if the test battery cell 100 generates some heat, the relay 230 and the power supply 240 may operate normally.

The power supply 240 may apply voltage to the relay 230 or release an application of voltage to the relay 230. The power supply 240 may be controlled by an operator. However, in some cases, automatic control of the power supply 240 may be implemented.

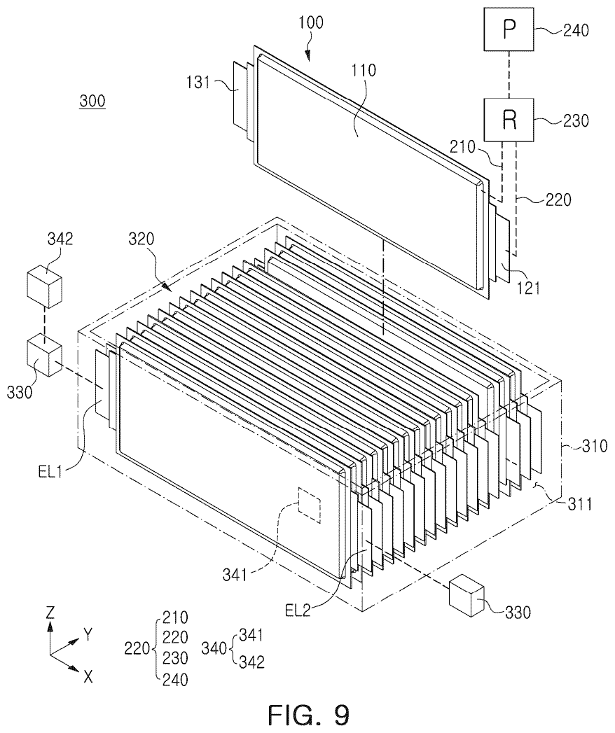

FIG. 9 is a schematic exploded perspective view of a battery apparatus 300 according to another embodiment of the present disclosure.

As illustrated in FIG. 9, the battery apparatus 300 according to an embodiment of the present disclosure may further include at least one sensor member 340 disposed in the internal space 311.

For example, at least one sensor member 340 may include a temperature sensor 341 measuring temperature and a voltage sensor 342 for measuring voltage.

The temperature sensor 341 may be attached to at least one battery cell 320, among the plurality of battery cells 320. The temperature sensor 341 may be attached to the battery cell 320 using tape or the like. The temperature sensor 341 may measure the temperature of the battery cell 320.

As the relay 230 is turned on and the temperature of the test battery cell 100 increases, the temperature of the plurality of battery cells 320 may also increase, and in this case, the temperature sensor 341 may measure the temperature of the battery cell 320. Accordingly, temperature changes in the battery cell 320 may be monitored in a thermal runaway environment.

The voltage sensor 342 may be connected to any one busbar assembly 330. The busbar assembly 330 may be provided on each of the first electrode leads EL1 and the second electrode leads EL2, and in this case, the voltage sensor 342 may be connected to the at least one busbar assembly 330.

The voltage sensor 342 may monitor the voltage applied to the test battery cell 100 and the plurality of battery cells 320.

The present disclosure, as described above, may simulate a thermal runaway situation. The present disclosure does not require a separate external heating device, or the like, and may utilize components within the battery apparatus 300 to induce a short circuit and thermal runaway.

Furthermore, the present disclosure may electrically connect the cathode tab 121 and the anode plate 130, for example, the anode active material region 132. The present disclosure may increase a temperature of the test battery cell 100 by short-circuiting the cathode tab 121 and the anode plate 130. Accordingly, the present disclosure may simulate a short circuit situation occurring when the cathode tab 121 is bent or folded in a usage environment of the actual battery apparatus 300.

The contents described above are merely examples of applying the principles of the present disclosure, and other components may be further included in a scope that does not exceed the scope of the present disclosure. Additionally, some components may be deleted and implemented in the above-described example embodiments, and each of the embodiments may be combined and implemented with each other.

What is claimed is:

1. A test battery cell, comprising:
a case including an accommodating space;
at least one cathode plate accommodated in the accommodating space and including a cathode tab;
at least one anode plate accommodated in the accommodating space and including an anode tab;
at least one separator separating the at least one cathode plate from the at least one anode plate; and
a conduction member in contact with the anode plate and including a material overlapping a material of the cathode tab.

2. The test battery cell of claim 1, wherein the cathode tab is formed of a material including aluminum.

3. The test battery cell of claim 1, wherein in the cathode tab, at least a partial region thereof is exposed to the outside of the case.

4. The test battery cell of claim 1, wherein the at least one cathode plate includes a plurality of cathode plates, and
the at least one anode plate includes a plurality of anode plates,
wherein in the separator, a single separator is folded and is interposed between the at least one cathode plate and the at least one anode plate.

5. A test system for a test battery cell, comprising:
a test battery cell including a case including an accommodating space, at least one cathode plate accommodated in the accommodating space and including a cathode tab, at least one anode plate accommodated in the accommodating space and including an anode tab, at least one separator separating the at least one cathode plate from the at least one anode plate, and a conduction member in contact with the anode plate and including a material overlapping a material of the cathode tab;
a first conductive line connected to the conductive member;
a second conductive line connected to the cathode tab;
a relay connected to the first and second conductive lines; and
a power supply connected to the relay and applying a voltage.

6. The test system for a test battery cell of claim 5, further comprising:
a first bolt penetrating through the conductive member and formed of an electrically conductive material.

7. The test system for a test battery cell of claim 5, further comprising:
a second bolt penetrating through the cathode tab and formed of an electrically conductive material; and
a second nut connected to the second bolt.

8. The test system for a test battery cell of claim 5, wherein the first conductive line and the second conductive line are exposed to the outside of the case, and
a connection region between the first conductive line and the relay and a connection region between the second conductive line and the relay are disposed outside the case.

9. A battery apparatus, comprising:
a housing including an internal space;
a plurality of battery cells accommodated in the housing, and respectively including an electrode assembly; and
a test system for a test battery cell, wherein at least a partial region thereof is accommodated in the housing,
wherein the test system for a test battery cell includes:
the test battery cell including a case including an accommodating space, at least one cathode plate accommodated in the accommodating space and including a cathode tab, at least one anode plate accommodated in the accommodating space and including an anode tab, at least one separator separating the at least one cathode plate from the at least one anode plate, and a conduction member in contact with the anode plate and including a material overlapping a material of the cathode tab;
a first conductive line connected to the conductive member;
a second conductive line connected to the cathode tab; and
a relay connected to the first and second conductive lines.

10. The battery apparatus of claim 9, further comprising:
a busbar assembly connecting the plurality of battery cells and the test battery cell.

11. The battery apparatus of claim 9, wherein the relay is disposed outside the housing.

12. The battery apparatus of claim 9, further comprising:
at least one sensor member disposed within the internal space.

13. The battery apparatus of claim 12, wherein the at least one sensor member includes:
a temperature sensor measuring temperature; and
a voltage sensor measuring voltage.

14. The battery apparatus of claim 9, further comprising:
a power supply connected to the relay and applying voltage.

15. The battery apparatus of claim 14, wherein the power supply is disposed outside the housing.
